(19) United States
(12) Patent Application Publication
(10) Pub. No.: US 2008/0304067 A1
(43) Pub. Date: Dec. 11, 2008

(54) Smoke detector

(75) Inventor: Adrien Maillard, Orleans (FR)

Correspondence Address: Davidson, Davidson & Kappel, LLC, 485 7th Avenue, 14th Floor, New York, NY, 10018, US

(73) Assignee: FABRICATION D'APPLICATIONS ET DE REALISATIONS ELECTRONIQUES, Pithiviers (FR)

(21) Appl. No.: 12/148,488

(22) Filed: Apr. 18, 2008

(30) Foreign Application Priority Data
Apr. 20, 2007 (FR) 07 54607

(51) Int. Cl. G01N 21/61

(52) U.S. Cl. 356/438

(57) ABSTRACT

The invention relates to a smoke detector designed to be placed in a room subjected to ambient light, the detector comprising:
emitter means suitable for emitting a light beam;
at least one reflector suitable for reflecting said light beam towards receiver means;
receiver means suitable for receiving the reflected light beam; and
a processor circuit suitable for receiving a signal that is characteristic of the emitted light beam and a signal that is characteristic of the received light beam, the processor circuit being suitable for generating a smoke detection signal as a function of said received signals.

The detector further comprises at least one mask disposed adjacent to the reflector, the mask being suitable for selecting those light beams that, at the inlet of said mask, have emission directions lying in a predetermined angular range.

This application claims priority French application FR 07 54607, filed on Apr. 20, 2007, the entire disclosure of which is incorporated by reference herein.

The present invention relates to a smoke detector designed to be placed in a room subjected to ambient light.

### BACKGROUND OF THE INVENTION

In particular, the invention relates to a smoke detector designed to be placed in a room subjected to ambient light, the detector comprising:
emitter means suitable for emitting at least one light beam in an emission direction;
at least one reflector suitable for reflecting said light beam towards receiver means;
receiver means suitable for receiving the reflected light beam; and
a processor circuit suitable for receiving a signal that is characteristic of the emitted light beam and a signal that is characteristic of the received light beam, the processor circuit being suitable for generating a smoke detection signal as a function of said received signals.

In such detectors, the emitter means and the receiver means are generally fastened to one wall of a room, the reflector being fastened to the opposite wall of said room. The light beam emitted by the emitter means is reflected by the reflector and is received by the receiver means. The processor circuit computes the ratio between, for example, the power of the emitted light beam and the power of the received light beam. That ratio is compared with values established during a training stage so as to define the degree of transparency of the air located between the emitter means, the receiver means, and the reflector. When smoke particles are present in the room, they reflect the emitted beam and the reflected beam in all directions, so that the value of the ratio computed by the processor circuit increases. When said ratio is greater than a predefined value, said ratio triggers an alarm signal.

Generally, the emitter means and the receiver means are positioned several meters (m) away from the reflector (in the range 5 m to 100 m away therefrom). The reflector is often of small size, e.g. of the order of about ten centimeters (cm).

When dust is deposited on the reflector or when the surface thereof is scratched or misshaped, the light reflected by the reflector is diffused in all directions so that only a fraction of that light is received by the receiver means.

Therefore, it is necessary to use receiver means that are very sensitive so that the received light beam is not negligible relative to the ambient light.

However, when the amount of sunlight increases in the room, such detectors are saturated in particular by the ambient light reflected by the defects and dust on the reflector and they are no longer capable of detecting the presence of smoke.

In order to solve those problems, it is known that such detectors can be provided with emitter means that are suitable for emitting a light beam that is modulated or a light beam that presents a single wavelength.

### SUMMARY OF THE INVENTION

An object of the invention is to provide an alternative smoke detector.

To this end, the invention provides a smoke detector further comprising at least one mask disposed adjacent to the reflector, the or each mask being suitable for selecting those light beams that, at the inlet of said mask, have emission directions lying in a predetermined angular range in a given axial plane.

In particular embodiments, the smoke detector has one or more of the following characteristics:
the mask has at least one wall extending in a plane that is substantially parallel to the emission direction of the beam;
the smoke detector further comprises an assembly of masks that are fastened together;
the or each mask is a tube;
the height and the diameter of the or each tube are chosen such that the ratio between the height and the diameter thereof is less than 2.5;
the or each mask is a polyhedron;
the or each mask is provided with at least one light absorption means, the or each light absorption means being disposed over at least a portion of the inside face of the wall of the or each mask, said portion of wall being adjacent to the reflector;
the or each absorption means comprises a projection of triangular section that has at least one face suitable for reflecting the light beam inside the mask;
the or each mask is made of an opaque plastics material; and
the wall of the or each mask has a thickness less than 2 millimeters (mm).

### BRIEF DESCRIPTION OF THE DRAWINGS

The invention can be better understood on reading the following description given solely by way of example and with reference to the accompanying drawings, in which:

FIG. 1 is a diagrammatic view of a first embodiment of the smoke detector of the invention;

FIG. 2 is a section view on the plane II-II through the mask shown in FIG. 1;

FIG. 3 is a diagrammatic perspective view from the front, showing a mask of a second embodiment of a smoke detector of the invention; and

FIG. 4 is a perspective view from the front, showing a mask of a third embodiment of a smoke detector of the invention.

### DETAILED DESCRIPTION

The invention relates to a smoke detector 2 suitable for being mounted in a room subjected to variations in daylight. Said smoke detector comprises emitter means 4 for emitting a light beam, a reflector 6 mounted remote from and opposite the emitter means 4, and receiver means 8 fastened facing the reflector 6.

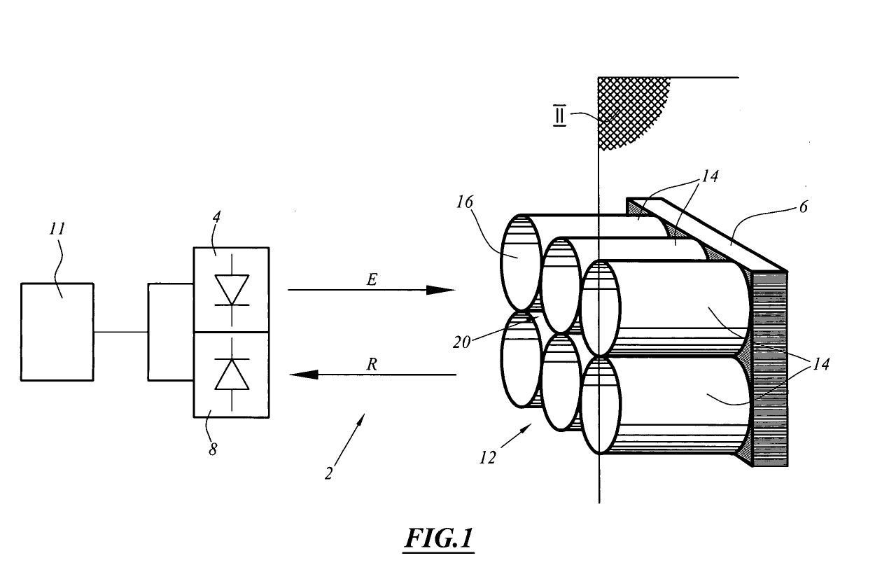

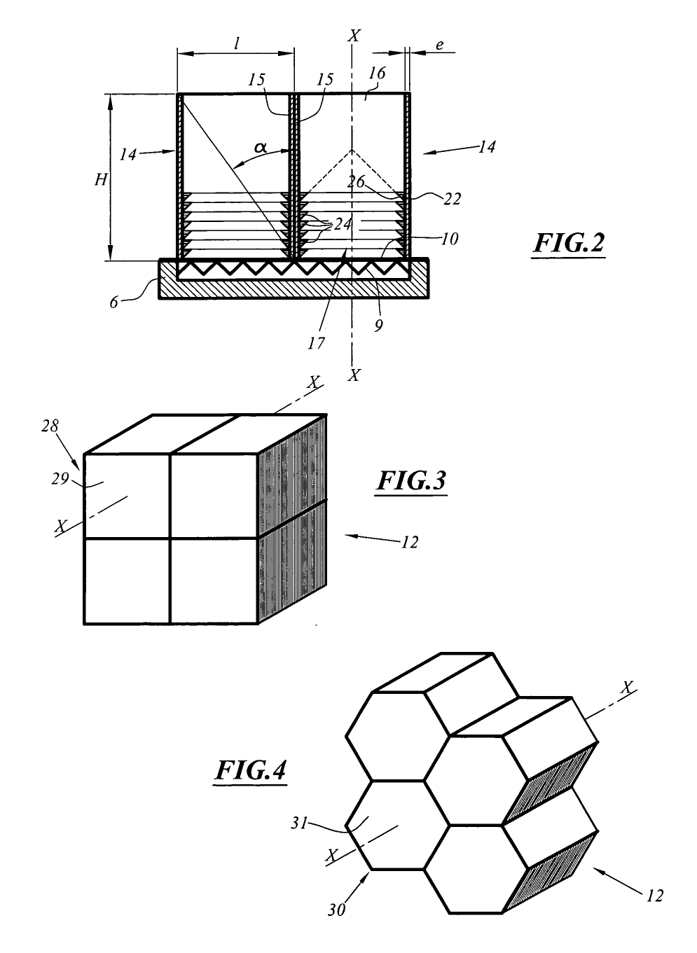

In the embodiment of the invention shown in FIG. 1, the smoke detector 2 is a linear smoke detector, i.e. the emitter means 4 and the receiver means 8 are fastened side by side to a vertical wall of the room, the reflector 6 being fastened to the opposite wall facing the emitter means 4 and the receiver means 8, in a direction E.

The emitter means 4 are suitable for emitting a light beam lying in the visible wavelength domain in the emission direction E. The light beam E is, for example, emitted at regular and predefined intervals of time.

In a variant, the light beam has a given wavelength corresponding, for example, to red light or to blue light.

Also in a variant, the light beam lies in the infrared wavelength domain.

The reflector 6 is a retro-reflector constituted by reflecting tetrahedrons 9 covered by a transparent plate 10, e.g. made of a plastics material.

The receiver means 8 are, for example, constituted by a photodiode.

The smoke detector 2 further comprises a processor circuit 11 connected to the emitter means 4 and to the receiver means 8.

The processor circuit 11 is suitable for computing the ratio between a signal that is characteristic of the light beam emitted by the emitter means 4 and a signal that is characteristic of the light beam received by the receiver means 8, and for generating an alarm signal when said ratio is greater than a value that is predetermined during a training stage.

In accordance with the invention, the smoke detector 2 further comprises a mask 12 disposed between the emitter means 4 and the receiver means 8, and applied against the reflector 6.

The mask 12 is suitable for passing those light beams that, at its inlet, have emission directions E lying within a certain permitted angular range and for not passing those light beams that, at the inlet of the mask, have propagation directions lying outside that permitted angular range.

The mask 12 is suitable for preventing a fraction of the beams coming from the ambient light from reflecting off the reflector 6.

The mask 12 is thus suitable for selecting the emitted light beams from a fraction of the light beams coming from the ambient light.

In the embodiment shown in FIG. 1, the mask 12 is made up of an assembly of six tubes 14 of circular section that are fastened together. Each tube 14 is formed by a cylindrical wall 15 and has an open face 16, 17 at each of its ends.

The mask 12 is fastened to the reflector 6 in a manner such that the open faces 16, 17 of each tube are positioned in planes that are perpendicular to the direction E of the emitted light beam so that the mask 12 forms a light duct suitable for passing those light beams that have propagation directions that are substantially parallel to the emission direction E.

The open face 16 disposed facing the emitter means 4 defines a permitted angular range within which the light beams are permitted to pass. This angular range is determined by the height H and by the diameter l of each tube 14. More precisely, this angular range is equal to an angle of 2α distributed on either side of the axis X-X′ in a given axial plane of the tube 14. The axis X-X is the axis parallel to the emission direction E that passes through the centre of the tube 14. The axial planes are defined as being the set of planes that contain the axis X-X. The angle α represents the limit angle of the light beams permitted to pass through each tube 14. Said angle α is obtained by the following formula:

α=arctan H/l

where H is the height and l is the diameter of each tube 14.

It has been determined by experiment that, in order to obtain a good emitted signal to received signal ratio, the H/l ratio must be less than 2.5.

For example, each tube 14 has a diameter of in the range 3 cm to 4 cm for a height of 2 cm.

Each tube 14 is made of an opaque material suitable for absorbing light. For example, each tube is made of a dark plastics material or of a metal.

The walls 15 of the tubes 14 are of thickness e that is as small as possible given the mechanical manufacturing constraints in order to reduce the reflection of light beams off said walls. For example a thickness e of 1 millimeter (mm) is used.

Empty spaces 20 are defined between the tubes 14 so that the light beams emitted by the emitter means 4 reach the reflector 6 by passing through said spaces.

Each tube 14 is further provided with absorption means 22 suitable for minimizing light beam reflection resulting from reflection inside the mask. Said absorption means 22 are made of a light-absorbent material such as a dark plastics material or a metal.

Said absorption means 22 are constituted by projections 24 formed by annular grooves provided around the periphery of the inside surface of the wall 15 of each tube.

Said projections 24 are of triangular section so that their faces 26 that are closer to the open face 17, adjacent to the reflector 6, define truncated cones. The inclination of the face 26 is determined such that a light beam arriving at a projection 24 is reflected away towards the wall of the tube opposite. Thus, the light beam remains inside the mask and is not diffused out of the tube towards the reflector.

In operation, those light beams that have emission directions lying within the permitted angular range [E±α] penetrate through the open face 16, are reflected by the reflector 6, and are sent back towards the receiver means 8 in a reflection direction R equal to the emission direction [E±the angle α].

In a variant, the projections 24 are replaced by furrows or striations.

In a variant, the mask 12 is formed by a single tube.

In a variant, the mask is formed by cones, the smaller through cross-section of each cone being fastened to the reflector 6.

In a variant, the mask is formed by an assembly of polyhedrons. The polyhedrons are preferably chosen such that they combine without leaving any empty spaces 20 between them.

In a second embodiment of the invention that is shown in FIG. 3, the mask 12 comprises four hollow square blocks 28 that are fastened together.

In this embodiment, the permitted angular range varies from a minimum value corresponding to the length of a side of the square to a maximum value corresponding to the diagonal of that square 29. The axial planes containing the permitted angular range comprise the set of plans containing the axis X-X. Said axis X-X is the axis that is parallel to the emission direction E and that passes through the intersection of the diagonals of the square 29.

In a third embodiment of the invention that is shown in FIG. 4, the mask 12 is formed by an assembly of four hollow hexahedrons 30.

In this embodiment, the permitted angular range varies from a minimum value equal to the distance between two opposite faces of the hexagon 31 to a maximum value corresponding to the distance between two opposite vertices of the hexagon 31. The axial planes containing the permitted angular range comprise the set of planes containing the axis X-X. In which case, the axis X-X is the axis that is parallel to the emission direction E and that passes through the center of gravity of the hexagon 31.

For implementing the invention, it is preferable for the mask to be constituted by geometrical shapes that have the smallest possible periphery for a given open face area because such shapes present a smaller reflection area capable of re-emitting the light beam. In other words, the preferred geometrical shapes are those that minimize the periphery to area ratio so as to increase the area capable of receiving and of reflecting the light beams.

In a variant of the invention, the detector is not a linear detector, i.e. the emitter means 4 are not disposed opposite the reflector 6.

This detector is a low-cost detector.

The wall 15 makes it possible to keep away those light beams that have an angle of incidence on the reflector 6 greater than the angle α x.

By using a plurality of masks, it is possible to select more finely the beams coming from the emitter means 4.

A tube-shaped mask makes it possible to reduce the reflections off the edges of the tube at the open face 16.

Similarly, by using a mask having a wall 15 of small thickness, it is possible to reduce the reflections of the incident beams off the edge of the mask at its open face.

The absorption means make it possible to avoid transmission of light beams generated by reflections inside the mask or against the wall 10 of the reflector 6. Such reflected beams can, for example, be generated by the presence of dust or of scratches on the reflector.

In a variant, a different number of tubes is used.

1-10. (canceled)

11. A smoke detector designed to be placed in a room subjected to ambient light, the detector comprising:
an emitter suitable for emitting at least one light beam in an emission direction;
a receiver;
at least one reflector suitable for reflecting the light beam towards the receiver;
the receiver suitable for receiving the reflected light beam; and
a processor circuit suitable for receiving a signal characteristic of the emitted light beam and a further signal characteristic of the received light beam, the processor circuit being suitable for generating a smoke detection signal as a function of the received signal and the received further signal; and
at least one mask disposed adjacent to the reflector, the at least one mask being suitable for selecting those light beams that, at an inlet of the mask, have emission directions lying in a predetermined angular range in a given axial plane.

12. The smoke detector according to claim 11, wherein the mask has at least one wall extending in a plane substantially parallel to the emission direction.

13. The smoke detector according to claim 11, wherein the at least one mask include an assembly of masks fastened together.

14. The smoke detector according to claim 1, wherein the or each mask is a tube.

15. The smoke detector according to claim 14, wherein a height and a diameter of the or each tube are chosen such that a ratio between the height and the diameter thereof is less than 2.5.

16. The smoke detector according to claim 11, wherein the or each mask is a polyhedron.

17. The smoke detector according to claim 11, wherein the or each mask is provided with at least one light absorber, the or each light absorber being disposed over at least a portion of the inside face of a wall of the or each mask, said portion of wall being adjacent to the reflector.

18. The smoke detector according to claim 17, wherein the or each absorber comprises a projection of triangular section that has at least one face suitable for reflecting the light beam inside the mask.

19. The smoke detector according to claim 11, wherein the or each mask is made of an opaque plastics material.

20. The smoke detector according to claim 12, wherein the wall of the or each mask has a thickness less than 2 mm.
